(19) United States
(12) Patent Application Publication
(10) Pub. No.: US 2013/0088588 A1
(43) Pub. Date: Apr. 11, 2013

(54) BORESCOPE SLEEVE

(71) Applicants: Joshua Lynn Scott, Jordan, NY (US); Gerard Frederick Beckhusen, Baldwinsville, NY (US)

(72) Inventors: Joshua Lynn Scott, Jordan, NY (US); Gerard Frederick Beckhusen, Baldwinsville, NY (US)

(73) Assignee: GENERAL ELECTRIC COMPANY, Schenectady, NY (US)

(21) Appl. No.: 13/268,902

(22) Filed: Oct. 7, 2011

(51) Int. Cl. H04N 7/18

(52) U.S. Cl. 348/85; 348/E07.085

(57) ABSTRACT

A sleeve for a borescope is disclosed. In one embodiment of the invention, the sleeve includes: an elastic material expandable to receive the borescope, the elastic material having an electrical resistance less than approximately 1 giga-ohm per square centimeter.

### BACKGROUND OF THE INVENTION

Aspects of the invention provide for sleeves for a borescope or a housing. Specifically, the subject matter disclosed herein relates to a borescope sleeve including an elastic material capable of expanding to receive at least a portion of a borescope.

The use of electrical equipment in environments featuring combustible gases (or, combustibles) is often regulated according to one or more certification requirements. Electrical devices may be subject to different certifications dependent upon the environment in which they are used. For example, different certification standards exist in open-air environments where combustibles are present versus closed-air (or, sealed) environments featuring combustibles.

One example standard for which certain electrical equipment must comply is “Class 1, Division 2” or, C1D2 certification, as outlined by the Canadian Standards Association International (CSA). The C1D2 certification applies to open-air environments where combustibles are present or may be present. Meeting the C1D2 certification for certain electrical devices can be difficult, as extensive testing may be required to determine whether the device can function as intended while limiting the chances that the device will cause a cause a combustion event (e.g., produce a spark).

### BRIEF DESCRIPTION OF THE INVENTION

A sleeve for a borescope is disclosed. In one embodiment of the invention, the sleeve includes: an elastic material expandable to receive the borescope, the elastic material having an electrical resistance less than approximately 1 giga-ohm per square centimeter.

A first aspect of the invention includes a sleeve for a borescope, the sleeve including: an elastic material expandable to receive the borescope, the elastic material having an electrical resistance less than approximately 1 giga-ohm per square centimeter.

A second aspect of the invention includes a sleeve for a housing having an external door, the sleeve including: an elastic material expandable to receive the housing and cover the external door, the elastic material having an electrical resistance less than approximately 1 giga-ohm per square centimeter.

A third aspect of the invention includes a borescope sleeve including: an elastic material sleeve for receiving an optical fiber bundle of a borescope device, the elastic material sleeve having an electrical resistance less than approximately 1 giga-ohm per square centimeter.

### BRIEF DESCRIPTION OF THE DRAWINGS

These and other features of this invention will be more readily understood from the following detailed description of the various aspects of the invention taken in conjunction with the accompanying drawings that depict various embodiments of the invention, in which:

FIG. 1 shows an environment including a schematic depiction of a borescope and a sleeve according to aspects of the invention.

FIG. 2 shows a distal end view of a borescope scope section and a sleeve according to aspects of the invention.

FIG. 3 shows an environment including a schematic depiction of a housing having an external door.

FIG. 4 shows an environment including a schematic depiction of a housing having an external door and a sleeve for the housing, according to aspects of the invention.

FIG. 5 shows a three-dimensional perspective view of a borescope and a sleeve according to aspects of the invention.

It is noted that the drawings of the invention are not to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

Aspects of the invention provide for sleeves for at least a portion of a borescope or a housing. Specifically, the subject matter disclosed herein relates to a borescope sleeve including an elastic material capable of expanding to receive a borescope, where the elastic material has an electrical resistance less than approximately 1 giga-ohm per square centimeter. The sleeve may be designed for use in at least partially covering the borescope in an environment where combustible gases are present.

The use of electrical equipment in environments featuring combustible gases (or, combustibles) is often regulated according to one or more certification requirements. Electrical devices may be subject to different certifications dependent upon the environment in which they are used. For example, different certification standards exist in open-air environments where combustibles are present versus closed-air (or, sealed) environments featuring combustibles. One example standard for which certain electrical equipment must comply is “Class 1, Division 2” or, C1D2 certification, as outlined by the Canadian Standards Association International (CSA). The C1D2 certification applies to open-air environments where combustibles are present or may be present. Meeting the C1D2 certification for certain electrical devices can be difficult, as extensive testing may be required to determine whether the device can function as intended while limiting the chances that the device will cause a cause a combustion event (e.g., produce a spark).

Approaches to meeting the C1D2 standard can include reducing the power level of the electrical device (e.g., operating at a low-power state), sealing the electrical device from the environment completely, or attempting to reduce the likelihood of generating a spark. Aspects of the invention include providing a sleeve for an electrical device (e.g., a borescope, endoscope, videoscope, etc., or a housing containing a plurality of electrical connectors) that substantially eliminates the likelihood of a spark (e.g., an air-emitted arc or other electrical discharge through the air) originating from the device.

More specifically, aspects of the invention include a sleeve for a borescope that substantially eliminates the likelihood of a spark originating from that borescope during operation in an open-air, combustion-present environment (e.g., a runway or airplane tarmac). Further aspects of the invention provide for sleeves for one or more types of housing located in an open-air environment where combustible gases are present. As is known in the art, these housings may include one or more electrical connectors (e.g., power outlets, USB ports, etc.) which are traditionally kept behind a closed and latched door of the housing. The sleeve configured to interact with the housing may eliminate the necessity for a latched door, as the sleeve retains the door in a closed position and substantially eliminates the occurrence of sparking from those electrical connectors external to the sleeve.

Conventionally, plastic covers are used to shield scopes (e.g., borescopes) in the field (e.g., in an open air environment) for the purposes of reducing sparking external to the covers. However, the electrical resistivity of these plastic covers is frequently too low to avoid the build-up of current to cause an electro-static discharge (ESD), even when doped according to desired specifications. These ESDs may cause undesirable sparking, and subsequent combustion. Additionally, plastic materials having higher electrical resistivity are frequently too brittle for continued use in the field. That is, these devices may experience critical material failures (e.g., cracking, stress, wear, etc.) after repeated impact or exposure to environmental conditions.

In contrast to the plastic covers used to shield scopes (or, borescopes) in an environment, aspects of the invention include a borescope sleeve including an elastic material having an electrical resistance less than approximately 1 giga-ohm per square centimeter. The elastic material can include a composition having a polyester/cotton material blended with microfine stainless steel fibers. The material can be configured to expand to fit a scope portion of the borescope, and may be relatively easily removed and reapplied by a human user due to its elastic properties. In some cases, the material may include a conductive, stretchable fabric (e.g., a woven material) such as a silver plated nylon woven with elastic fibers.

In some embodiments, the sleeve can include a sensor affixed to an interior portion of the elastic material. The sensor may be any form of contact-based, optical, or other sensor configured to determine that the sleeve is in place over the intended portion of the borescope (or the housing). The sensor can sense contact (or proximity) between the sleeve and the borescope (or the housing), and provide a signal to a receiver (including e.g., a display device such as a user interface, a light-emitting diode, etc.) for indicating that the sensor is in place. That is, the sensor can include a transmitter for providing the signal (e.g., via wireless or hard-wired means) to the receiver for indicating the sensor is in place.

Additionally, the sleeve can include a fastener for affixing the elastic material to a surface of the borescope (or the housing). The fastener can include any form of adhesive, latch, tab, clamp, etc. capable of at least partially retaining the sleeve against the surface of the borescope. In some cases, a fastener is not required, as the sleeve can retain itself against the surface of the borescope (or housing) due to its elastic properties.

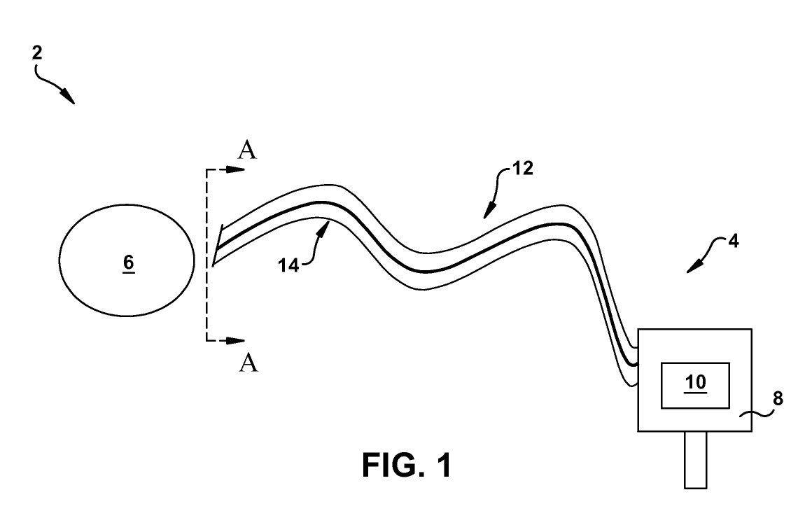

Turning to FIG. 1, a schematic illustration of an environment 2 including a borescope sleeve is shown according to embodiments of the invention. It is understood that the environment 2 may be characterized by an open-air environment where combustibles (e.g., combustible gases) are present. In this environment 2, a borescope 4 may be useful for examining certain objects 6 (e.g., portions of engines, turbines, manufactured, machined or cast parts, etc., in particular, in the aircraft industry). In some cases, the borescope 4 can include a base section 8 (which can include controls, an interface or display 10, e.g., a graphical user interface or other conventional display). The borescope 4 can also include a flexible and steerable scope section 12, which is connected to the base section 8 and provides optical data regarding the object 6.

As is known in the art, the borescope 4 can be used as on optical device for inspection of difficult-to-reach (or view) areas of an object of interest (e.g., object 6). In some cases, one section (e.g., the base section 8 or the scope section 12) can include a light source, which is projected via optical fibers in the scope section 12 to the portion of the object 6. When the light is reflected from the object an optical relay transmits the image back to the base section 8 for viewing through the interface, or display 10. The scope section 12 can be a substantially rigid section, or in some embodiments (e.g., as shown in FIG. 1), the scope section 12 can be a substantially flexible section.

Also shown in FIG. 1, in a cut-away view, is a borescope sleeve 14 substantially surrounding the scope section 12. The borescope sleeve 14 is shown extending substantially the length of the scope section 12, and can be continuous with (e.g., contacting) the base section 8 from which the scope section 12 is connected, or may be disconnected from the base section 8. In any case, the borescope sleeve 14 can substantially insulate the scope section 12 from the surrounding environment 2. That is, the borescope sleeve 14 can provide an electrically insulative function in preventing sparking from the scope section 12 while having a sufficiently low electrical resistivity to prevent overheating of the borescope sleeve 14, or the build-up of undesirable electro-static discharge (ESD). More particularly, the borescope sleeve 14 can be sufficiently conductive to allow for the flow of electricity through the contained scope section 12, which has a plurality of optical fibers for transmitting the light and corresponding returned image. However, the borescope sleeve 14 will also be durable enough to withstand an impact force associated with dropping the sleeve 14 containing the scope section 12 repeatedly from a height of approximately 2-3 meters. As noted herein, the borescope sleeve 14 can be composed of an interwoven conductive material such as a polyester/cotton blended fabric with microfine stainless steel fibers. This material can have an electrical resistance less than approximately 1 giga-ohm per square centimeter. The sleeve 14 can be substantially elastic such that it expands to receive the scope section 12, and then contracts to fit substantially flush against an outer surface of the scope section 12 after application.

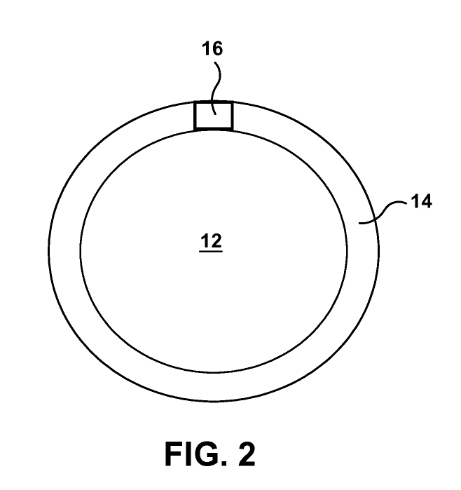

FIG. 2 shows a close-up cut-away distal end view of the scope section 12 surrounded (radially) by the sleeve 14 (as viewed from perspective A-A shown in FIG. 1). As shown, the sleeve 14 can be substantially flush against the outer surface of the scope section 12. In some cases, the sleeve 14 can be approximately 0.01-0.02 inches thick, and in a particular embodiment, can be approximately 0.02 inches thick. In some embodiments, a fastener 16 may be added to the sleeve 14 to secure the sleeve onto the scope section 12. The fastener 16 can be any form of conventional fastening device including a clip, binding, adhesive, etc. In some cases, the fastener 16 (or the sleeve 14) can include a magnet. The magnet can be used for the purpose of indicating that the sleeve 14 is engaged with the scope section 12. In one embodiment, where the fastener 14 or the sleeve 14 includes a magnet, the scope section 12 can also include a Hall effect sensor configured to sense the presence of the magnet in proximity to the scope section 12. As is known in the art, a Hall effect sensor includes a transducer which varies its output voltage in response to a change in the magnetic field proximate the sensor. Any conventional Hall effect sensor may be used according to embodiments of the invention.

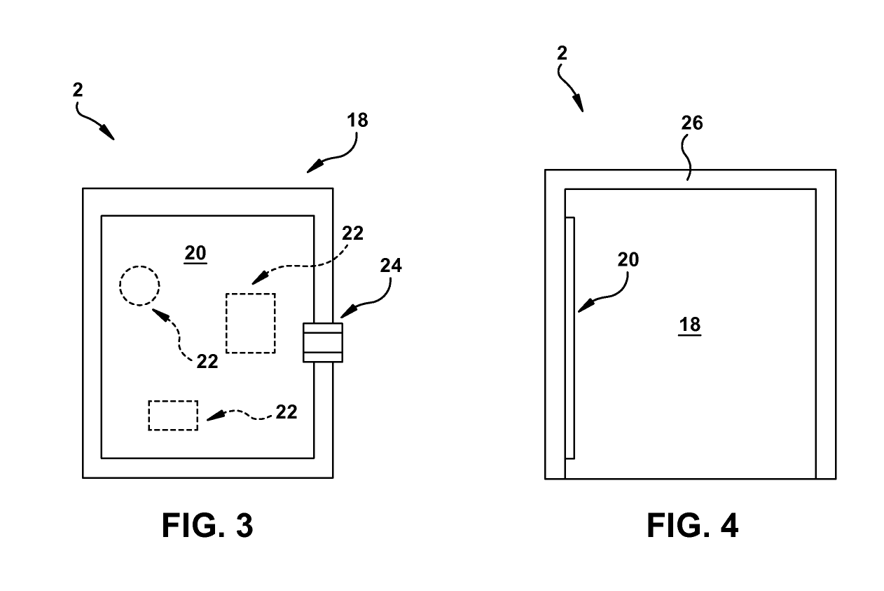

Turning to FIG. 3, a front schematic view of a housing 18 (e.g., an electrical housing) having an external door 20 within the environment 2 is shown according to conventional approaches. The housing 18 can include a plurality of connection points (or connectors) 22, shown in phantom behind the external door 20. The connection points 22 can include any conventional connectors configured to provide electrical connection between devices or conduits within the housing 18 and an external device (e.g., an external electrical device). For example, the connection points 22 can include conventional power outlets, USB ports, etc. As is known in the art, these connection points 22 may be capable of sparking or otherwise causing an electrical discharge or arc, which may interact with combustible gases in the surrounding environment 2 to cause undesirable combustion.

Also shown is a fastener 24 configured to secure the external door 20 closed, thereby preventing exposure of the connection points 22 to the environment 2 (including the combustible gases that may be present in the environment). In accordance with conventional safety standards (e.g., CSA standards), a fastener 24 is required to secure the external door 20 closed such that the connection points 22 are prevented from providing any potential electrical spark within the environment 2.

FIG. 4 shows a cut-away side view of the housing 18 in the environment 2 of FIG. 3, further including a sleeve 26 for the housing 18. The sleeve 26 can be configured to cover the housing 18 as well as the external door 20, and provide insulation to the housing 18 and the door 20. The sleeve 26 can take the place of the fastener 24 in the conventional approach, thereby effectively retaining the external door 20 in a closed position. In some cases, the sleeve 26 can include an elastic material similar to that described with reference to the elastic material of sleeve 14 (FIGS. 1 and 2). That is, the sleeve 26 can include an elastic material having an electrical resistance less than approximately 1 giga-ohm per square centimeter, which may include a fabric. The sleeve 26, or the housing 18, can further include a sensor (e.g., a proximity sensor such as a Hall effect sensor) for indicating that the sleeve 26 is engaged with the housing 18. The sensor may further include a transmitter in some circumstances, as described with reference to the sleeve 14 of FIGS. 1 and 2. It is understood that the sleeve 26 of FIG. 4 and the sleeve 14 of FIGS. 1 and 2 may, in some cases, vary only in their dimensions and ability to expand to fit the different applications of interest. In either case, the sleeves described herein can provide insulative and protective functions within combustible gas-present environments, thereby allowing for particular electrical devices to meet, e.g., safety standards described herein.

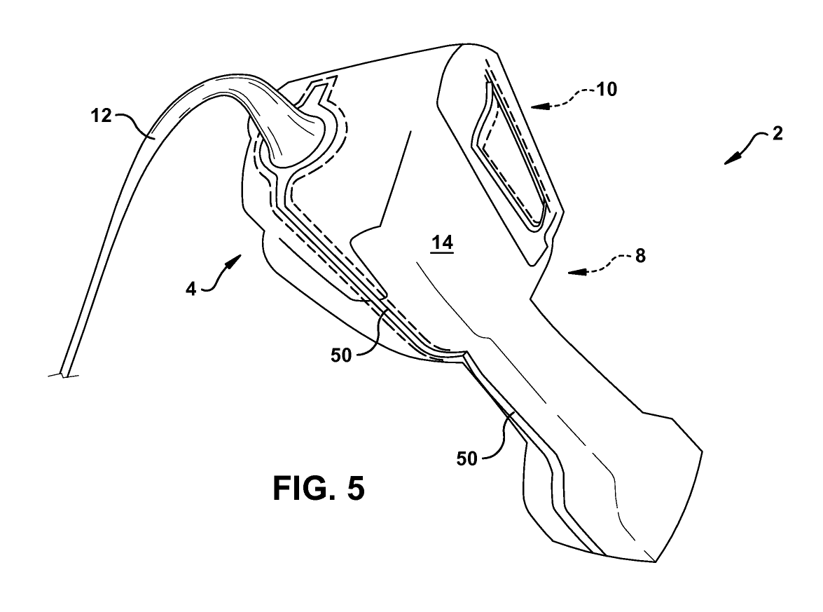

FIG. 5 shows a three-dimensional perspective view of a borescope 4 and a sleeve 14 according to aspects of the invention. As shown, the borescope 4 and sleeve 14 are positioned within environment 2, and the sleeve 14 can include an elastic material expandable to receive the borescope base section 8. The borescope sleeve 14 in this embodiment can be designed to substantially cover the base section 8 (obstructed, indicated in phantom), leaving the scope section 12 substantially uncovered (or exposed to the environment 2). As described herein, in some cases, the elastic material of the sleeve 14 has an electrical resistance less than approximately 1 giga-ohm per square centimeter. In some cases, the elastic material includes a fabric having silver plated nylon woven with elastic fibers.

In some embodiments, the sleeve 14 can include a seam 50 spanning substantially an axial length of the borescope base section 8, where the sleeve 14 is substantially sealed along the seem 50. In some cases, the seam 50 can extend along a side of the borescope base section 8 opposing the interface (or display) 10 (obstructed, shown in phantom). In some cases, the sleeve 14 can cover substantially all of the surfaces of the base section 8, except where the scope section 12 extends from the base section 8.

As described with respect to the sleeves herein, the sleeve 14 can further include a sensor affixed to an interior portion of the elastic material, where the sensor is configured to sense contact between the elastic material and the borescope 4. As noted herein, in some cases the sleeve 14 can further include a transmitter operably connected to the sensor, the transmitter for transmitting a signal indicating the contact between the elastic material (sleeve 14) and the borescope 4. In some cases, the sleeve 14 can include a fastener operably connected to the elastic material, the fastener for affixing the elastic material to a surface of the borescope 4.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A sleeve for a borescope, the sleeve comprising:
an elastic material expandable to receive the borescope, the elastic material having an electrical resistance less than approximately 1 giga-ohm per square centimeter.

2. The sleeve of claim 1, wherein the elastic material includes a fabric having silver plated nylon woven with elastic fibers.

3. The sleeve of claim 1, further comprising a sensor affixed to an interior portion of the elastic material.

4. The sleeve of claim 3, wherein the sensor is configured to sense contact between the elastic material and the borescope.

5. The sleeve of claim 4, further comprising a transmitter operably connected to the sensor, the transmitter for transmitting a signal indicating the contact between the elastic material and the borescope.

6. The sleeve of claim 1, further comprising a fastener operably connected to the elastic material, the fastener for affixing the elastic material to a surface of the borescope.

7. A sleeve for a housing having an external door, the sleeve comprising:
an elastic material expandable to receive the housing and cover the external door, the elastic material having an electrical resistance less than approximately 1 giga-ohm per square centimeter.

8. The sleeve of claim 7, wherein the elastic material includes a fabric having silver plated nylon woven with elastic fibers.

9. The sleeve of claim 7, further comprising a sensor affixed to an interior portion of the elastic material.

10. The sleeve of claim 9, wherein the sensor is configured to sense contact between the elastic material and the housing.

11. The sleeve of claim 10, further comprising a transmitter operably connected to the sensor, the transmitter for transmitting a signal indicating the contact between the elastic material and the housing.

12. The sleeve of claim 7, wherein the elastic material is further configured to retain the external door in a closed position.

13. A borescope sleeve comprising:
an elastic material sleeve for receiving an optical fiber bundle of a borescope device,
the elastic material sleeve having an electrical resistance less than approximately 1 giga-ohm per square centimeter.

14. The sleeve of claim 13, wherein the elastic material sleeve includes a fabric having silver plated nylon woven with elastic fibers.

15. The sleeve of claim 13, further comprising a sensor affixed to an interior portion of the elastic material sleeve.

16. The sleeve of claim 15, wherein the sensor is configured to sense contact between the elastic material sleeve and the borescope.

17. The sleeve of claim 16, further comprising a transmitter operably connected to the sensor, the transmitter for transmitting a signal indicating the contact between the elastic material sleeve and the borescope.

18. The sleeve of claim 13, further comprising a fastener operably connected to the elastic material, the fastener for affixing the elastic material sleeve to a surface of the borescope.
